(19) United States
(12) Patent Application Publication
(10) Pub. No.: US 2018/0246592 A1
(43) Pub. Date: Aug. 30, 2018

(54) ELECTRICALLY CONDUCTIVE FILMS, ASSEMBLIES, AND METHODS OF REMOVING STATIC ELECTRIC CHARGE FROM ELECTRICALLY CONDUCTIVE PATTERNS

(71) Applicant: 3M INNOVATIVE PROPERTIES COMPANY, St. Paul, MN (US)

(72) Inventors: Siarhei V. Savich, Chino, CA (US); Daniel J. Theis, Mahtomedi, MN (US); Qin Fei Chen, Singapore (SG); Saujit Bandhu, Singapore (SG); Ravi Palaniswamy, Singapore (SG); Matthew S. Stay, Minneapolis, MN (US)

(21) Appl. No.: 15/745,808

(22) PCT Filed: Jul. 7, 2016
(86) PCT No.: PCT/US2016/041335

§ 371 Date: Jan. 18, 2018

Related U.S. Application Data
(60) Provisional application No. 62/194,953, filed on Jul. 21, 2015.

(51) Int. Cl. G06F 3/044

(52) U.S. Cl. CPC G06F 3/044; G06F 2203/04103

(57) ABSTRACT

Electrically conductive films are provided. An electrically conductive film includes a dielectric substrate having a first region adapted to be used in a touch sensor and a second region, adjacent to the first region, not adapted to be used in the touch sensor. The electrically conductive film further includes electrically conductive spaced apart electrodes disposed on the substrate in the first region and adapted to form drive or receive electrodes in the touch sensor, and an electrically conductive pattern disposed on the substrate in the second region. Each electrode extends into the second region and is electrically and physically connected to the conductive first pattern, the conductive first pattern electrically connecting the plurality of the first electrodes. Also, assemblies and methods for removing static electric charge from electrically conductive patterns are provided.

### FIELD

This application relates generally to electrically conductive films and assemblies, with particular application to removing static electric charge from electrically conductive patterns of the films and assemblies.

### BACKGROUND

Touch sensitive devices allow a user to conveniently interface with electronic systems and displays by reducing or eliminating the need for mechanical buttons, keypads, keyboards, and pointing devices. For example, a user can carry out a complicated sequence of instructions by simply touching an on-display touch screen at a location identified by an icon.

There are several types of technologies for implementing a touch sensitive device including, for example, resistive, infrared, capacitive, surface acoustic wave, electromagnetic, near field imaging, etc. Capacitive touch sensing devices have been found to work well in a number of applications. In many touch sensitive devices, the input is sensed when a conductive object in the sensor is capacitively coupled to a conductive touch implement such as a user's finger. Generally, whenever two electrically conductive members come into proximity with one another without actually touching, a capacitance is formed therebetween. In the case of a capacitive touch sensitive device, as an object such as a finger approaches the touch sensing surface, a tiny capacitance forms between the object and the sensing points in close proximity to the object. By detecting changes in capacitance at each of the sensing points and noting the position of the sensing points, the sensing circuit can recognize multiple objects and determine the characteristics of the object as it is moved across the touch surface.

Flexible printed circuits employed in touch sensitive devices typically include a single layer film or multilayer film, which contains electrical conductive circuitry that may be easily burned or otherwise damaged due to electrostatic discharge (ESD) generated, for instance, during the manufacturing process.

### SUMMARY

The present disclosure provides electrically conductive films, assemblies including the electrically conductive films, and methods of removing static electric charge from electrically conductive patterns of films and assemblies. The electrically conductive films may be used in touch sensors.

In a first aspect, an electrically conductive film for use in a touch sensor is provided. The electrically conductive film includes a dielectric substrate having a first region adapted to be used in a touch sensor and a second region, adjacent to the first region, not adapted to be used in the touch sensor. The electrically conductive film further includes a plurality of substantially parallel electrically conductive spaced apart first electrodes disposed on the substrate in the first region and adapted to form a plurality of drive or receive electrodes in the touch sensor, and an electrically conductive first pattern disposed on the substrate in the second region. Each first electrode extends into the second region and is electrically and physically connected to the conductive first pattern, the conductive first pattern electrically connecting the plurality of the first electrodes.

In a second aspect, another electrically conductive film is provided. The electrically conductive film includes a web of dielectric material, a plurality of electrically and physically intersecting electrically conductive rows and columns disposed on the web and defining a plurality of closed cells, and a plurality of substantially parallel electrically conductive spaced apart electrodes disposed on the web in each closed cell and adapted to form a plurality of drive or receive electrodes in a touch sensor. Each electrode in a closed cell terminates at least one of the rows and columns in the plurality of the rows and columns defining the closed cell.

In a third aspect, yet another electrically conductive film for use in a touch sensor is provided. The electrically conductive film includes a dielectric substrate having a first region adapted to be used in a touch sensor and a second region, adjacent to the first region, not adapted to be used in the touch sensor.

The electrically conductive film further includes a plurality of substantially parallel electrically conductive spaced apart first electrodes disposed on the substrate in the first region and adapted to form a plurality of drive or receive electrodes in a viewing region of the touch sensor, an electrically conductive first pattern disposed on the substrate in the second region, and a plurality of electrically conductive spaced apart first traces disposed on the substrate. A first end of each trace is electrically and physically connected to a corresponding first electrode in the first region, an opposite second end of the trace extends into the second region and is electrically connected to the conductive first pattern, the conductive first pattern electrically connecting the plurality of the first electrodes, and at least portions of the first traces are adapted to be used in a non-viewing border region of the touch sensor.

In a fourth aspect, an assembly is provided. The assembly includes a web of dielectric material having a length direction along a longer length dimension of the web and a width direction, perpendicular to the length direction, along a shorter width dimension of the web, and an electrically conductive elongated first pattern disposed on the web and extending along the length direction. The assembly further includes a plurality of substantially parallel electrically conductive spaced apart first electrodes disposed on the web and oriented along the width direction and adapted to form a plurality of drive or receive electrodes in a touch sensor, the first electrodes being physically and electrically isolated from the first pattern, and a drum positioned adjacent the web and comprising an electrically conductive second pattern disposed on an external surface of the drum. As the web moves along the length direction, the drum rotates in synchronism with the web, such that when the second pattern physically and electrically contacts a first electrode at a first location on the second pattern, the second pattern does not electrically contact the first pattern, and when the second pattern physically and electrically contacts the first electrode at a different second location on the second pattern, the second pattern physically contacts the first pattern.

In a fifth aspect, a method of removing static electric charge from an electrically conductive pattern disposed on a web of dielectric material is provided. The method includes providing a web of dielectric material having first and second electrically conductive patterns disposed thereon, the second pattern electrically isolated from the first pattern and connected to a ground, the first pattern having a static electric charge thereon, and bringing an electrically conductive discharge path in electrical and physical contact with the first, but not the second, pattern so that at least a portion of the static electric charge transfers from the first pattern to the discharge path. The method further includes bringing the electrically conductive discharge path in electrical and physical contact with the second pattern while maintaining contact with the first pattern so that at least a portion of the static charge transfers from the discharge path to the ground second pattern.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The invention is further explained with reference to the drawing wherein:

FIG. 1 is a schematic view of a touch device;

FIG. 2 is a schematic side view of a portion of a touch panel used in a touch device;

FIG. 3 is a schematic side view of an electrically conductive film construction during manufacture;

FIG. 4 is a schematic side view of the electrically conductive film construction of FIG. 3 being peeled apart;

FIG. 5 is a schematic side view of the peeled electrically conductive film of FIG. 4 being contacted with a conductive grounding roller;

FIG. 6 is a schematic side view of the electrically conductive film of FIG. 3 being peeled apart and experiencing electrostatic discharge damage;

FIG. 7 is a schematic top view of an exemplary electrically conductive film;

FIG. 8a is a schematic top view of portions of a further exemplary electrically conductive film;

FIG. 8b is a schematic top view of portions of a still further exemplary electrically conductive film;

FIG. 9 is a schematic top view of another exemplary electrically conductive film;

FIG. 10a is a schematic view of an exemplary assembly;

FIG. 10b is a schematic view of the exemplary assembly of 10a in operation;

FIG. 11 is a schematic view of an exemplary roller and a portion of an exemplary electrically conductive film;

FIG. 12a is a schematic view of the assembly of Comparative Example 1 in operation;

FIG. 12b is a schematic view of the assembly of Example 1 in operation; and

FIG. 13 is a schematic top view of a portion of an exemplary silver nanowire pattern on a substrate.

These figures are not to scale and are intended to be merely illustrative and not limiting. In the figures, like reference numerals designate like elements.

### DETAILED DESCRIPTION

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

The recitation of numerical ranges by endpoints includes all numbers subsumed within that range (e.g., 1 to 5 includes 1, 1.5, 2, 2.75, 3, 3.80, 4, and 5). As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Touch screens are typically covered by a multilayer film, which comprises the electrical conductive circuitry of the touch screen; however the circuit is susceptible to damage due to electrostatic discharge (ESD) during manufacturing process, transportation and final assembly. Such static voltage mostly builds up when peeling the top layer of the multilayer film, plus touching the structure with other charged objects may also affect the static voltage, for example during unreeling, rubbing, separating, covering, and other process steps. During peeling, for instance, the film can be charged up to a couple of kilovolts, thus creating a high risk of undesirable electrostatic discharge (ESD) during manufacturing, testing, transportation, and customer usage. Aspects according to the present disclosure address the problem of high static build up on the electrically conductive film so that ESD events can be minimized or eliminated. For instance, novel patterns are formed on the electrically conductive film, which are connected to the existing circuit patterns, providing methods to keep potential level of the whole film close to zero.

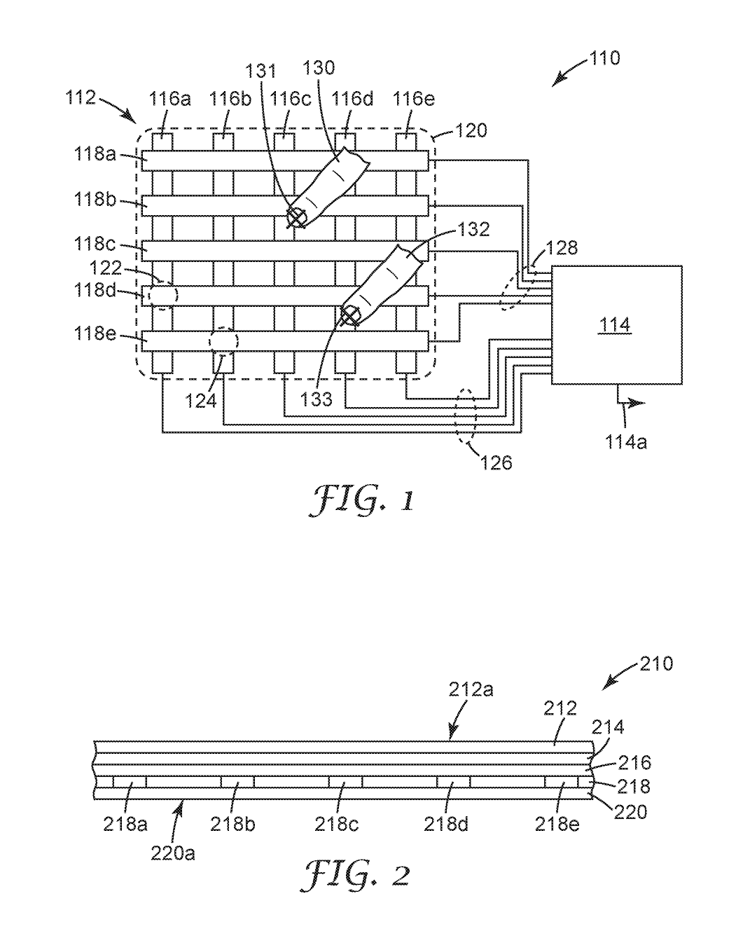

In FIG. 1, an exemplary touch device 110 is shown. The device 110 includes a touch panel 112 connected to electronic circuitry, which for simplicity is grouped together into a single schematic box labeled 114 and referred to collectively as a controller.

The touch panel 112 is shown as having a 5×5 matrix of column electrodes 116a-e and row electrodes 118a-e, but other numbers of electrodes and other matrix sizes can also be used. The panel 112 is typically substantially transparent so that the user is able to view an object, such as the pixilated display of a computer, hand-held device, mobile phone, or other peripheral device, through the panel 112. The boundary 120 represents the viewing area of the panel 112 and also preferably the viewing area of such a display, if used. The electrodes 116a-e, 118a-e are spatially distributed, from a plan view perspective, over the viewing area 120. For ease of illustration the electrodes are shown to be wide and obtrusive, but in practice they may be relatively narrow and inconspicuous to the user. Further, they may be designed to have variable widths, e.g., an increased width in the form of a diamond- or other-shaped pad in the vicinity of the nodes of the matrix in order to increase the inter-electrode fringe field and thereby increase the effect of a touch on the electrode-to-electrode capacitive coupling. In exemplary embodiments the electrodes may be composed of indium tin oxide (ITO) or other suitable electrically conductive materials. From a depth perspective, the column electrodes may lie in a different plane than the row electrodes (from the perspective of FIG. 1, the column electrodes 116a-e lie underneath the row electrodes 118a-e) such that no significant ohmic contact is made between column and row electrodes, and so that the only significant electrical coupling between a given column electrode and a given row electrode is capacitive coupling. The matrix of electrodes typically lies beneath a cover glass, plastic film, or the like, so that the electrodes are protected from direct physical contact with a user's finger or other touch-related implement. An exposed surface of such a cover glass, film, or the like may be referred to as a touch surface.

The capacitive coupling between a given row and column electrode is primarily a function of the geometry of the electrodes in the region where the electrodes are closest together. Such regions correspond to the “nodes” of the electrode matrix, some of which are labeled in FIG. 1. For example, capacitive coupling between column electrode 116a and row electrode 118d occurs primarily at node 122, and capacitive coupling between column electrode 116b and row electrode 118e occurs primarily at node 124. The 5×5 matrix of FIG. 1 has 25 such nodes, any one of which can be addressed by controller 114 via appropriate selection of one of the control lines 126, which individually couple the respective column electrodes 116a-e to the controller, and appropriate selection of one of the control lines 128, which individually couple the respective row electrodes 118a-e to the controller.

When a finger 130 of a user or other touch implement comes into contact or near-contact with the touch surface of the device 110, as shown at touch location 131, the finger capacitively couples to the electrode matrix. The finger draws charge from the matrix, particularly from those electrodes lying closest to the touch location, and in doing so it changes the coupling capacitance between the electrodes corresponding to the nearest node(s). For example, the touch at touch location 131 lies nearest the node corresponding to electrodes 116c/118b. As described further below, this change in coupling capacitance can be detected by controller 114 and interpreted as a touch at or near the 116a/118b node. Preferably, the controller is configured to rapidly detect the change in capacitance, if any, of all of the nodes of the matrix, and is capable of analyzing the magnitudes of capacitance changes for neighboring nodes so as to accurately determine a touch location lying between nodes by interpolation. Furthermore, the controller 114 advantageously is designed to detect multiple distinct touches applied to different portions of the touch device at the same time, or at overlapping times. Thus, for example, if another finger 132 touches the touch surface of the device 110 at touch location 133 simultaneously with the touch of finger 130, or if the respective touches at least temporally overlap, the controller is preferably capable of detecting the positions 131, 133 of both such touches and providing such locations on a touch output 114a. The number of distinct simultaneous or temporally overlapping touches capable of being detected by controller 114 is preferably not limited to 2, e.g., it may be 3, 4, or more, depending on the size of the electrode matrix.

The controller 114 preferably employs a variety of circuit modules and components that enable it to rapidly determine the coupling capacitance at some or all of the nodes of the electrode matrix. For example, the controller preferably includes at least one signal generator or drive unit. The drive unit delivers a drive signal to one set of electrodes, referred to as drive electrodes. In the embodiment of FIG. 1, the column electrodes 116a-e may be used as drive electrodes, or the row electrodes 118a-e may be so used. The drive signal is preferably delivered to one drive electrode at a time, e.g., in a scanned sequence from a first to a last drive electrode. As each such electrode is driven, the controller monitors the other set of electrodes, referred to as receive electrodes. The controller 114 may include one or more sense units coupled to all of the receive electrodes. For each drive signal that is delivered to each drive electrode, the sense unit(s) generate response signals for the plurality of receive electrodes. Preferably, the sense unit(s) are designed such that each response signal comprises a differentiated representation of the drive signal. For example, if the drive signal is represented by a function f(t), which may represent voltage as a function of time, then the response signal may be or comprise, at least approximately, a function g(t), where g(t)=d f(t)/dt. In other words, g(t) is the derivative with respect to time of the drive signal f(t). Depending on the design details of the circuitry used in the controller 114, the response signal may include: (1) g(t) alone; or (2) g(t) with a constant offset (g(t)+a); or (3) g(t) with a multiplicative scaling factor (b*g(t)), the scaling factor capable of being positive or negative, and capable of having a magnitude greater than 1, or less than 1 but greater than 0; or (4) combinations thereof, for example. In any case, an amplitude of the response signal is advantageously related to the coupling capacitance between the drive electrode being driven and the particular receive electrode being monitored. Of course, the amplitude of g(t) is also proportional to the amplitude of the original function f(t). Note that the amplitude of g(t) can be determined for a given node using only a single pulse of a drive signal, if desired.

The controller may also include circuitry to identify and isolate the amplitude of the response signal. Exemplary circuit devices for this purpose may include one or more peak detectors, sample/hold buffer, and/or low-pass filter, the selection of which may depend on the nature of the drive signal and the corresponding response signal. The controller may also include one or more analog-to-digital converters (ADCs) to convert an analog amplitude to a digital format. One or more multiplexers may also be used to avoid unnecessary duplication of circuit elements. Of course, the controller also preferably includes one or more memory devices in which to store the measured amplitudes and associated parameters, and a microprocessor to perform the necessary calculations and control functions.

By measuring an amplitude of the response signal for each of the nodes in the electrode matrix, the controller can generate a matrix of measured values related to the coupling capacitances for each of the nodes of the electrode matrix. These measured values can be compared to a similar matrix of previously obtained reference values in order to determine which nodes, if any, have experienced a change in coupling capacitance due to the presence of a touch.

Turning now to FIG. 2, we see there a schematic side view of a portion of a touch panel 210 for use in a touch device. The panel 210 includes a front layer 212, a first electrode layer 214 comprising a first set of electrodes, an insulating layer 216, a second electrode layer 218 comprising a second set of electrodes 218a-e preferably orthogonal to the first set of electrodes, and a rear layer 220. The exposed surface 212a of the layer 212, or the exposed surface 220a of the layer 220, may be or comprise the touch surface of the touch panel 210.

Referring to FIG. 3, a schematic side view is provided of a multilayer electrically conductive film construction 300. More particularly, the electrically conductive film construction 300 comprises a substrate 310 having a conductive layer 320 disposed on a major surface of the substrate 310. A conductive pattern is provided by selectively depositing a resist material 325 comprising an insulating material in a pattern on the conductive layer 320. Above the resist material 325, a polymeric layer 330 is laminated to the construction. Last, a liner 340 is affixed on the polymeric layer 330.

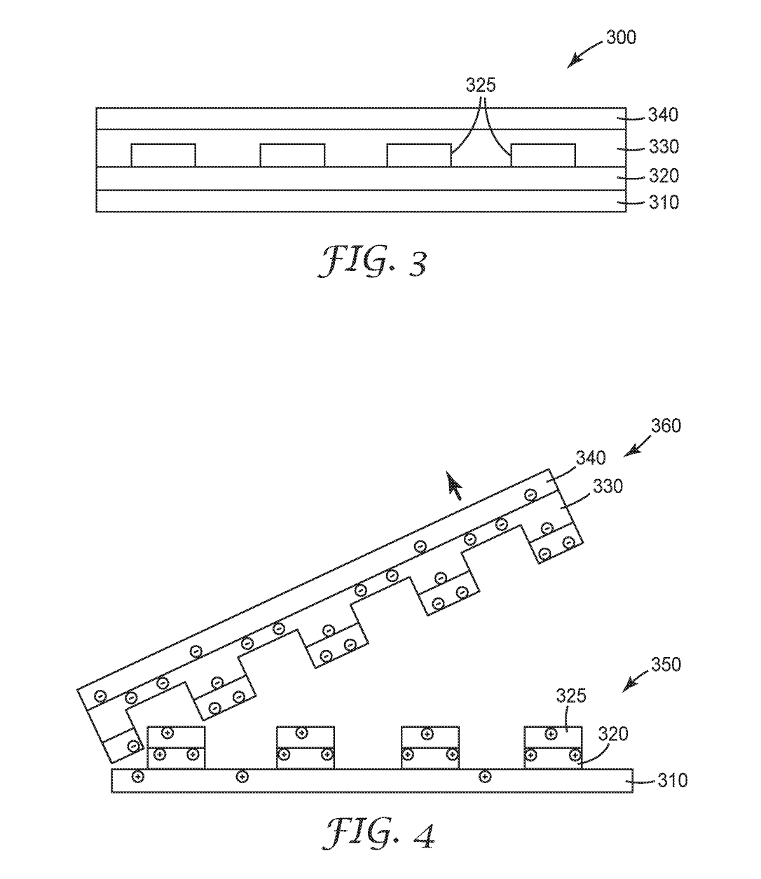

Turning to FIG. 4, a schematic side view of the electrically conductive film construction 300 of FIG. 3 being peeled apart is shown. As the construction 300 is peeled apart, an electrically conductive film 350 is provided, including the substrate 310, resist material 325, and portions of the conductive layer 320 located underneath the resist material 325. From the construction 300 a disposable film 360 is generated, including the polymeric layer 330, portions of the conductive layer 320 not located underneath the resist material 325, and the liner 340. The process of peeling apart an electrically conductive film construction 300 generates charge localization in different materials throughout the construction. As shown in FIG. 4, the plus symbols (+) indicate positive charges and the minus symbols (−) indicate negative charges, and in this illustrative embodiment the electrically conductive film 350 has an overall positive charge and the disposable film 360 has an overall negative charge. Hence, the substrate may be considered an insulated substrate having charged conductive material on it. Each portion of the conductive layer 320 can carry its own charge and a surface electrical potential gradient may exist on the electrically conductive film 350 after the delamination (e.g., peeling) process. This potential gradient creates a condition for ESD discharge between separate portions of the conductive layer 320, which can cause structural damage or melting/burning of one or more portions of the conductive layer 320.

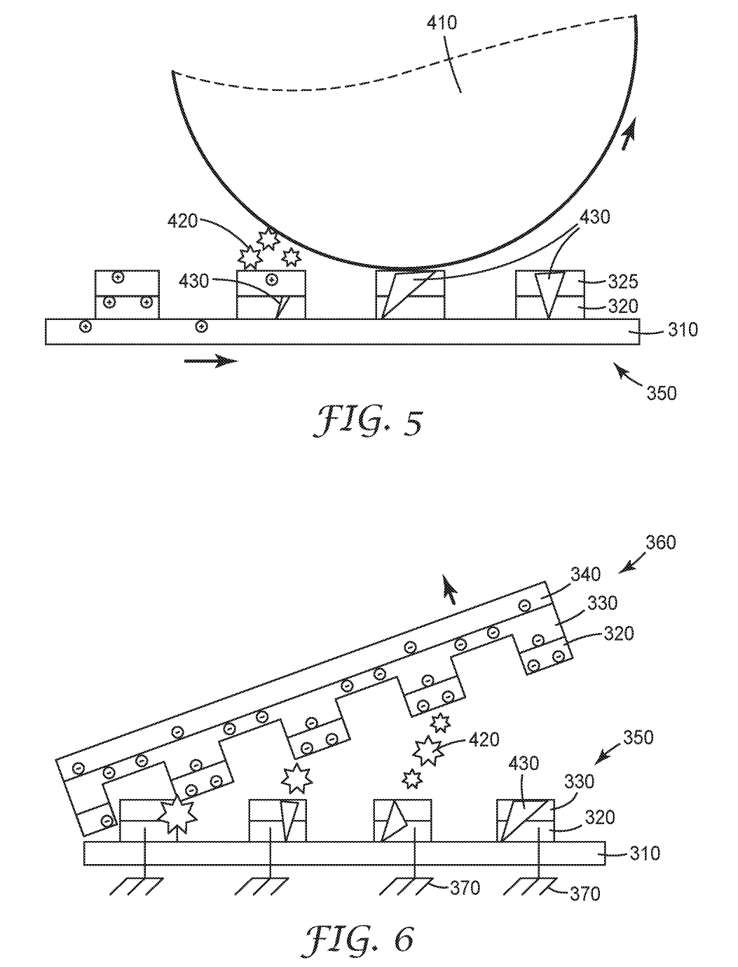

Referring now to FIG. 5, the electrically conductive film 350 of FIG. 4 is shown passing through a drive module following delamination. When each individually charged portion of the conductive layer 320 approaches or touches the conductive grounded roller 410, electrostatic discharge 420 may occur, causing ESD damage 430 to the electrically conductive film 350 at one or more portions of the conductive layer 320. Turning to FIG. 6, even in a case where each portion of the conductive layer 320 is individually grounded, such as via traces 370, it is possible to generate ESD damage 430 because the disposable film 360 can still accrue some charge and a potential difference between the disposable film 360 and the electrically conductive film 350 may increase as the distance between the layers increases.

In a first aspect of the present disclosure, an electrically conductive film for use in a touch sensor is provided. The electrically conductive film includes a dielectric substrate having a first region adapted to be used in a touch sensor and a second region, adjacent to the first region, not adapted to be used in the touch sensor. The electrically conductive film further includes a plurality of substantially parallel electrically conductive spaced apart first electrodes disposed on the substrate in the first region and adapted to form a plurality of drive or receive electrodes in the touch sensor, and an electrically conductive first pattern disposed on the substrate in the second region. Each first electrode extends into the second region and is electrically and physically connected to the conductive first pattern, the conductive first pattern electrically connecting the plurality of the first electrodes.

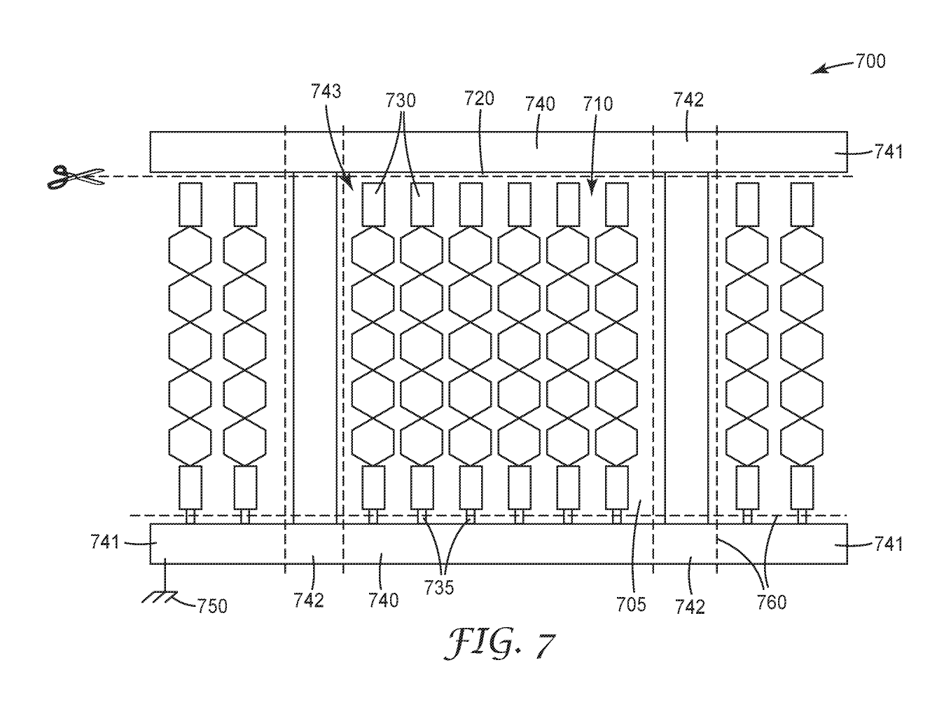

For instance, referring to FIG. 7, a schematic top view is provided of an exemplary electrically conductive film 700. The electrically conductive film 700 includes a dielectric substrate 705 having a first region 710 adapted to be used in a touch sensor and a second region 720, adjacent to the first region 710, not adapted to be used in the touch sensor. The electrically conductive film 700 further includes a plurality of substantially parallel electrically conductive spaced apart first electrodes 730 disposed on the substrate in the first region 710 and adapted to form a plurality of drive or receive electrodes in the touch sensor, and an electrically conductive first pattern 740 disposed on the substrate in the second region. Each first electrode 730 extends into the second region 720 and is electrically and physically connected 735 to the conductive first pattern 740, the conductive first pattern 740 electrically connecting the plurality of the first electrodes 730. The electrically conductive first pattern 740 is disposed on the substrate in the second region 720 and is electrically connected to ground 750. In many embodiments, the second region 720 completely encloses the first region 710 and the electrically conductive first pattern 740 completely encloses the plurality of the first electrodes 730. FIG. 7 further illustrates dashed lines 760 along which one could cut the electrically conductive film 700 to separate the first region 710 from the second region 720.

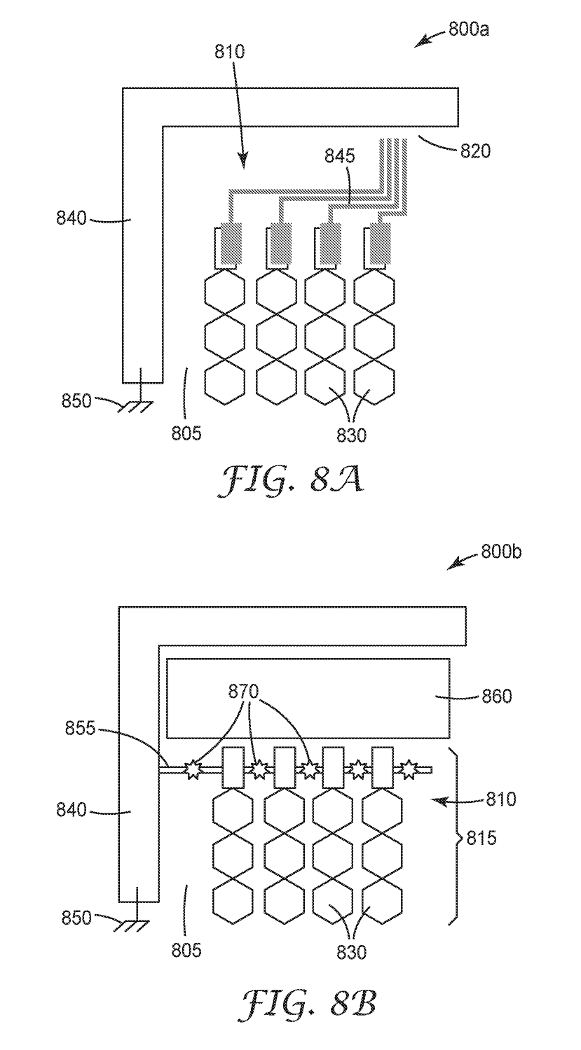

Referring to FIG. 8a, in certain embodiments of an electrically conductive film 800a, an electrically conductive second pattern 845 is disposed on the substrate 805 in the first region 810 and at least partially overlays and contacts the first electrodes 830. The first electrodes 830 are adapted to be used in a viewing region of a touch sensor and the second pattern 845 is adapted to be used in a non-viewing border region of the touch sensor. The second pattern 845 preferably extends into the second region 820 and electrically and physically connects to the conductive first pattern 840.

Referring to FIG. 8b, however, in various embodiments of an electrically conductive film 800b, the first region 810 comprises an electrode region 815 comprising the plurality of the first electrodes 830 and adapted to be used primarily in a viewing region of a touch sensor, and a trace region 860 is adapted to support a plurality of electrically conductive traces and be used primarily in a non-viewing border region of the touch sensor, the trace region 860 not comprising any electrically conductive pattern thereon. Rather, the plurality of the first electrodes 830 are electrically and physically connected to the conductive first pattern 840 by a conductive jumper 855. The terms “conductive jumper” and “shunt” are used interchangeably herein. The conductive jumper 855 can subsequently be cut (e.g., by a laser) at a number of cut points 870 to separate the plurality of first electrodes 830 from each other prior to use in a touch sensor.

In certain embodiments of electrically conductive films according to the present disclosure, the film further comprises an electrically conductive third pattern disposed on the substrate on a surface opposite of the electrically conductive first pattern. Moreover, certain embodiments of electrically conductive films can be prepared by forming electrically conductive patterns on separate dielectric substrates followed by lamination of the substrates together to form a multilayer electrically conductive film.

The dielectric substrate comprises any suitable polarizable electrically insulating substrate material, for instance and without limitation, a printable polymer (e.g., polyethylene terephthalate (PET)), a sol-gel metal oxide, or an anodic oxide. Additional suitable printable polymers include but are not limited to polyester, polyimide, polyamide-imide, polytetrafluoroethylene, polypropylene, polyethylene, polyphenylene sulfide, polyethylene naphthalate, polycarbonate, silicone rubber, ethylene propylene diene rubber, polyurethane, acrylates, silicones, natural rubber, epoxies, and synthetic rubber adhesive. Examples of useful dielectric thicknesses include thicknesses between 0.05 microns and 20 microns, preferably between 0.1 and 10 microns, most preferably between 0.25 and 5 microns. In many embodiments, the dielectric substrate comprises a multilayer polymeric film.

Suitable materials for each electrically conductive pattern (first pattern, second, pattern, etc.) include for example and without limitation, copper, silver, aluminum, gold, alloys thereof, carbon nanotubes, and combinations thereof Typically, the plurality of electrodes are present in the electrically conductive film in the form of wires, micro-wires (e.g., metal mesh), nano-wires, a conductive layer, or a combination thereof, preferably in the form of nano-wires.

Similar to the electrically conductive pattern, suitable materials for each of the plurality of electrodes (first electrodes, second electrodes, etc.) include for example and without limitation, copper, silver, gold, alloys thereof, indium tin oxide (ITO), and combinations thereof

When employed in a touch sensor application, the electrically conductive film typically lies beneath a cover glass, plastic film, durable coating, or the like, so that the electrodes, conductive patterns, etc., are protected from direct physical contact with a user's finger or other touch object (such as a stylus). An exposed surface of such a cover glass, film, or the like is referred to as the touch surface of touch panel.

The above details regarding materials, substrate thicknesses, etc., also apply to the electrically conductive films and assemblies referred to in the second through fifth aspects below.

In a second aspect of the disclosure, another electrically conductive film is provided. The electrically conductive film includes a web of dielectric material, a plurality of electrically and physically intersecting electrically conductive rows and columns disposed on the web and defining a plurality of closed cells, and a plurality of substantially parallel electrically conductive spaced apart electrodes disposed on the web in each closed cell and adapted to form a plurality of drive or receive electrodes in a touch sensor. Each electrode in a closed cell terminates at least one of the rows and columns in the plurality of the rows and columns defining the closed cell.

For example, turning back to FIG. 7, the electrically conductive film 700 includes a web of dielectric material 710, a plurality of electrically and physically intersecting electrically conductive rows 741 and columns 742 disposed on the web 710 and defining a plurality of closed cells 743, and a plurality of substantially parallel electrically conductive spaced apart electrodes 730 disposed on the web 710 in each closed cell 743 and adapted to form a plurality of drive or receive electrodes in a touch sensor. Each electrode 730 in a closed cell 743 terminates at least one of the rows 741 and columns 742 in the plurality of the rows 741 and columns 742 defining the closed cell 743.

In a third aspect of the disclosure, yet another electrically conductive film for use in a touch sensor is provided. The electrically conductive film includes a dielectric substrate having a first region adapted to be used in a touch sensor and a second region, adjacent to the first region, not adapted to be used in the touch sensor. The electrically conductive film further includes a plurality of substantially parallel electrically conductive spaced apart first electrodes disposed on the substrate in the first region and adapted to form a plurality of drive or receive electrodes in a viewing region of the touch sensor, an electrically conductive first pattern disposed on the substrate in the second region, and a plurality of electrically conductive spaced apart first traces disposed on the substrate. A first end of each trace is electrically and physically connected to a corresponding first electrode in the first region, an opposite second end of the trace extends into the second region and is electrically connected to the conductive first pattern, the conductive first pattern electrically connecting the plurality of the first electrodes, and at least portions of the first traces are adapted to be used in a non-viewing border region of the touch sensor.

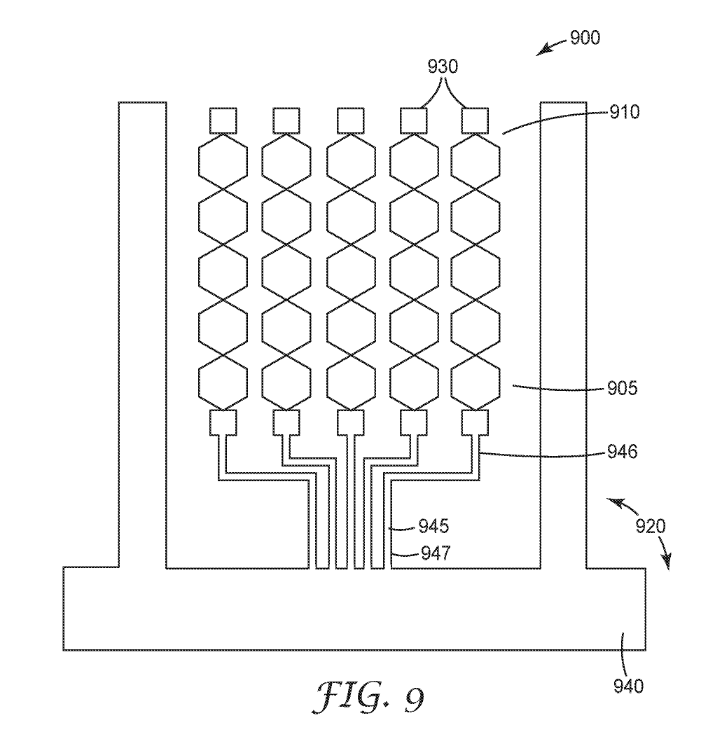

For example, referring to FIG. 9, the electrically conductive film 900 includes a dielectric substrate 905 having a first region 910 adapted to be used in a touch sensor and a second region 920, adjacent to the first region, not adapted to be used in the touch sensor. The electrically conductive film 900 further includes a plurality of substantially parallel electrically conductive spaced apart first electrodes 930 disposed on the substrate 905 in the first region 910 and adapted to form a plurality of drive or receive electrodes in a viewing region of the touch sensor, an electrically conductive first pattern 940 disposed on the substrate 905 in the second region 920, and a plurality of electrically conductive spaced apart first traces 945 disposed on the substrate 905. A first end of each trace 946 is electrically and physically connected to a corresponding first electrode 930 in the first region 910, an opposite second end of the trace 947 extends into the second region 920 and is electrically connected to the conductive first pattern 940, the conductive first pattern 940 electrically connecting the plurality of the first electrodes 930, and at least portions of the first traces 945 are adapted to be used in a non-viewing border region of the touch sensor.

In contrast to the embodiments illustrated in FIGS. 7, 8a, and 8b, the electrically conductive film embodiment shown in FIG. 9 eliminates the need for conductive jumpers and/or an additional cutting step. Rather, the conductive patterns shown in FIG. 9 connect all conductive materials together and provides the possibility for grounding the whole structure.

In certain embodiments, the plurality of electrically conductive spaced apart first traces comprise silver pads printed on top of electrically conductive patterns, and may provide the necessary contact with any external circuits. The connections between these silver pads is still implemented from the electrically conductive patterns. This may be useful to resolve potential alignment issues on closely spaced horizontal electrically conductive patterns due to insufficient silver ink printer resolution. The top interconnect may have a typical silver material and shape.

In a fourth aspect, an assembly is provided. The assembly includes a web of dielectric material having a length direction along a longer length dimension of the web and a width direction, perpendicular to the length direction, along a shorter width dimension of the web, and an electrically conductive elongated first pattern disposed on the web and extending along the length direction. The assembly further includes a plurality of substantially parallel electrically conductive spaced apart first electrodes disposed on the web and oriented along the width direction and adapted to form a plurality of drive or receive electrodes in a touch sensor, the first electrodes being physically and electrically isolated from the first pattern, and a drum positioned adjacent the web and comprising an electrically conductive second pattern disposed on an external surface of the drum. As the web moves along the length direction, the drum rotates in synchronism with the web, such that when the second pattern physically and electrically contacts a first electrode at a first location on the second pattern, the second pattern does not electrically contact the first pattern, and when the second pattern physically and electrically contacts the first electrode at a different second location on the second pattern, the second pattern physically contacts the first pattern.

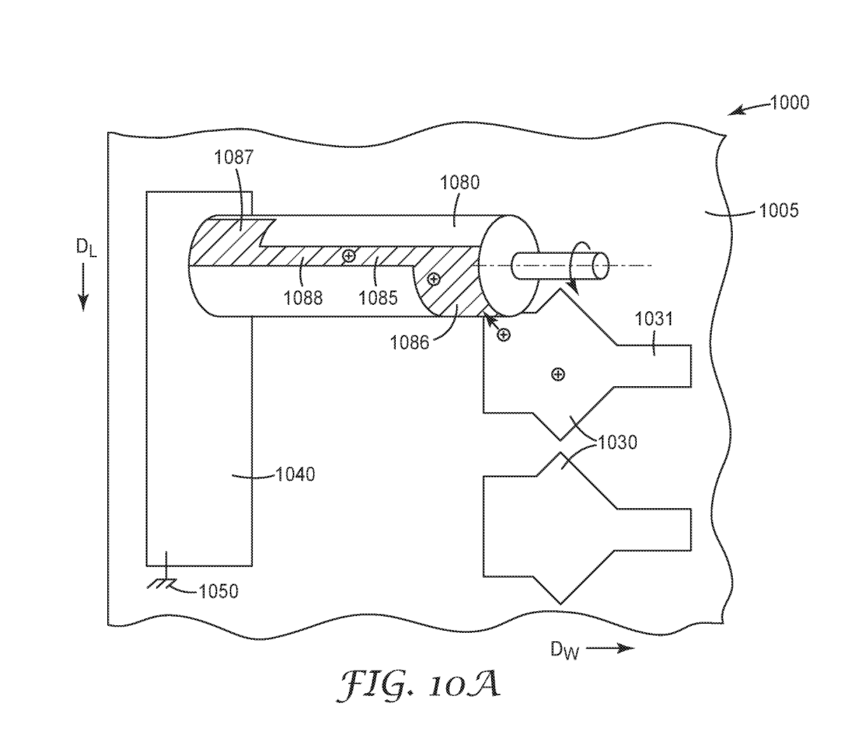

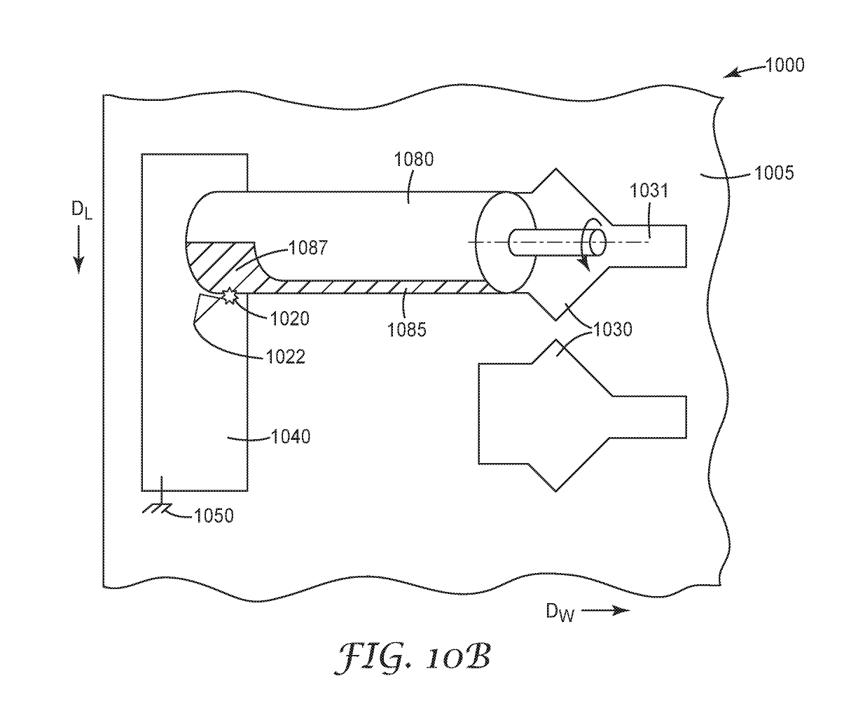

For example, referring to FIG. 10a, the assembly 1000 includes a web of dielectric material 1005 having a length direction along a longer length dimension of the web D_{L} and a width direction, perpendicular to the length direction, along a shorter width dimension of the web D_{W}, and an electrically conductive elongated first pattern 1040 disposed on the web and extending along the length direction D_{L}. The assembly 1000 further includes a plurality of substantially parallel electrically conductive spaced apart first electrodes 1030 disposed on the web 1005 and oriented along the width direction D_{W} and adapted to form a plurality of drive or receive electrodes in a touch sensor, the first electrodes 1030 being physically and electrically isolated from the first pattern 1040, and a drum 1080 positioned adjacent the web and comprising an electrically conductive second pattern 1085 disposed on an external surface of the drum. Referring to FIG. 10b, as the web 1005 moves along the length direction D_{L}, the drum 1080 rotates in synchronism with the web 1005, such that when the second pattern 1085 physically and electrically contacts a first electrode 1031 at a first location on the second pattern 1086, the second pattern does not electrically contact the first pattern 1040, and when the second pattern 1085 physically and electrically contacts the first electrode 1031 at a different second location on the second pattern 1085, the second pattern 1085 physically contacts the first pattern 1040.

In many embodiments, as the web 1005 moves along the length direction D_{L} and the drum 1080 rotates in synchronism with the web 1005, when the second pattern 1085 first comes in contact with a first electrode 1031, the second pattern 1085 does not electrically contact the first pattern 1040, but when the drum 1080 rotates further while maintaining contact with the first electrode 1031, the second pattern 1085 contacts the first pattern 1040.

In the assembly illustrated in FIG. 10a, the second pattern 1085 comprises an elongated connecting section 1088 extending along a rotation axis of the drum and opposing first 1086 and second end section 1087 extending from respective first 1086 and second ends 1087 of the connecting section in opposite directions along a circumference of the drum 1080.

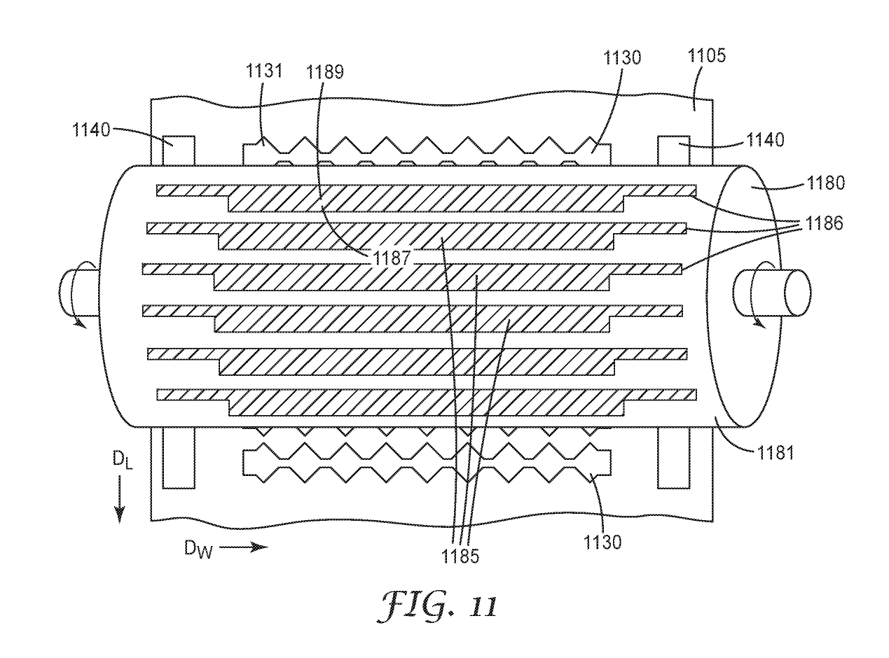

Referring now to FIG. 11, in certain embodiments the drum 1180 comprises a plurality of electrically conductive substantially parallel spaced apart second patterns 1185 disposed on the external surface 1181 of the drum 1180 and electrically isolated from each other, such that as the web 1105 moves along the length direction D_{L}, the drum 1180 rotates in synchronism with the web 1105 such that each second pattern 1185 contacts a corresponding first electrode 1131 at substantially a same first location 1187 on the second pattern 1185 so that the second pattern 1185 does not electrically contact the first pattern 1140, and each second pattern 1185 contacts the corresponding first electrode 1131 at substantially a same second location 1189 on the second pattern 1185 so that the second pattern 1185 electrically contacts the first pattern 1140.

Referring to both FIGS. 10a and 11, in certain embodiments, each of the plurality of the first electrodes 1030, 1130 is oriented along the shorter width dimension D_{W} of the web 1005, 1105.

In a fifth aspect, a method of removing static electric charge from an electrically conductive pattern disposed on a web of dielectric material is provided. The method includes providing a web of dielectric material having first and second electrically conductive patterns disposed thereon, the second pattern electrically isolated from the first pattern and connected to a ground, the first pattern having a static electric charge thereon, and bringing an electrically conductive discharge path in electrical and physical contact with the first, but not the second, pattern so that at least a portion of the static electric charge transfers from the first pattern to the discharge path. The method further includes bringing the electrically conductive discharge path in electrical and physical contact with the second pattern while maintaining contact with the first pattern so that at least a portion of the static charge transfers from the discharge path to the ground second pattern.

For example, referring to FIGS. 10a and 10b, the method includes providing a web of dielectric material 1005 having first 1030 and second electrically conductive patterns 1040 disposed thereon, the second pattern 1040 electrically isolated from the first pattern 1030 and connected to a ground 1050, the first pattern 1030 having a static electric charge thereon, and bringing an electrically conductive discharge path 1080 in electrical and physical contact with the first pattern 1030, but not the second pattern 1040 so that at least a portion of the static electric charge transfers from the first pattern 1030 to the discharge path 1080. The method further includes bringing the electrically conductive discharge path 1080 in electrical and physical contact with the second pattern 1040 while maintaining contact with the first pattern 1030 so that at least a portion of the static charge transfers from the discharge path 1080 to the ground second pattern 1040.

Advantageously, the assembly is configured to relocate a potential discharge point from a functional area of an electrically conductive film to a nonfunctional zone of the electrically conductive film to minimize the possibility of creating ESD damage in portions of the electrically conductive film that are to be used in a product such as a touch sensor. Suitable exemplary shapes of an electrically conductive elongated pattern 1085, 1185 on a drum 1080, 1180 are illustrated in FIGS. 10a and 11, and variations of the shapes are contemplated that are configured to contact a charged electrically conductive area followed by contacting an electrically conductive grounded area, wherein the electrically conductive elongated pattern on the drum does not initially touch both the charged electrically conductive area and the electrically conductive grounded area at the same time.

Stated another way, during the movement of an electrically conductive film through an apparatus, contact of the electrically conductive elongated pattern on the drum to the charged electrically conductive area occurs without the electrically conductive elongated pattern touching the electrically conductive grounded area in the non-functional region of the electrically conductive film. Thus, during the first contact of the drum's electrically conductive elongated pattern with charged electrically conductive area, an ESD event does not happen, but rather the static charge from the charged electrically conductive area is redistributed between the charged electrically conductive area and the electrically conductive elongated pattern of the drum. As a result, the electric potential of the charged electrically conductive area and the electrically conductive elongated pattern on the drum is equalized, as shown in FIG. 10a. Since the electrically conductive film continues to move and the drum rotates in synchronicity, the electrically conductive elongated pattern will touch the electrically conductive grounded area and ESD discharge of the whole system may take place. It is hence necessary to design the shape and size of the electrically conductive elongated pattern as well as the diameter of the drum to provide the proper alignment of the electrically conductive elongated pattern to the charged electrically conductive area and to the electrically conductive grounded area.

Optionally, the drum is rotated using mechanical gear that synchronizes the drum with the movement of the web. Other electronic control solutions including position determining sensors, control circuits, and step motor drivers may also be used.

Typically, a drum for use in the assembly is made from dielectric material, for example and without limitation, polystyrene, polyester, polypropylene, polyethylene, polyvinyl chloride, polytetrafluoroethylene, polyacrylonitrile, silicone rubber, ethylene propylene diene rubber, natural rubber, and synthetic rubber adhesive. The electrically conductive elongated pattern on the drum is formed from any suitable conductive material, for example and without limitation, copper, nickel, silver, brass, gold, platinum, or alloys thereof. Preferably, the materials for the drum and for the electrically conductive elongated pattern on the drum are selected to have similar triboelectric charges.

Various modifications and alterations of this invention will be apparent to those skilled in the art without departing from the spirit and scope of this invention, and it should be understood that this invention is not limited to the illustrative embodiments set forth herein. For example, the reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

The following items are exemplary embodiments according to aspects of the present invention:

Item 1 is an electrically conductive film for use in a touch sensor, comprising:

a dielectric substrate comprising a first region adapted to be used in a touch sensor and a second region, adjacent to the first region, not adapted to be used in the touch sensor;

a plurality of substantially parallel electrically conductive spaced apart first electrodes disposed on the substrate in the first region and adapted to form a plurality of drive or receive electrodes in the touch sensor; and

an electrically conductive first pattern disposed on the substrate in the second region, each first electrode extending into the second region and electrically and physically connected to the conductive first pattern, the conductive first pattern electrically connecting the plurality of the first electrodes.

Item 2 is the electrically conductive film of item 1, wherein the second region completely encloses the first region and the electrically conductive first pattern completely encloses the plurality of the first electrodes.

Item 3 is the electrically conductive film of item 1 further comprising an electrically conductive second pattern disposed on the substrate in the first region and at least partially overlaying and contacting the first electrodes, the first electrodes adapted to be used in a viewing region of a touch sensor and the second pattern adapted to be used in a non-viewing border region of the touch sensor.

Item 4 is the electrically conductive film of item 3, wherein the second pattern extends into the second region and electrically and physically connects to the conductive first pattern.

Item 5 is the electrically conductive film of item 1, wherein the first region comprises an electrode region comprising the plurality of the first electrodes and adapted to be used primarily in a viewing region of a touch sensor, and a trace region adapted to support a plurality of electrically conductive traces and be used primarily in a non-viewing border region of the touch sensor, the trace region not comprising any electrically conductive pattern thereon.

Item 6 is the electrically conductive film of any of items 1 to 5, wherein the dielectric substrate comprises a printable polymer, a sol-gel metal oxide, or an anodic oxide.

Item 7 is the electrically conductive film of any of items 1 to 6, wherein the thickness of the dielectric substrate is between 0.1 and 10 microns.

Item 8 is the electrically conductive film of any of items 1 to 7, wherein the electrically conductive first pattern comprises copper, silver, aluminum, gold, alloys thereof, or a combination thereof.

Item 9 is the electrically conductive film of any of items 1 to 8, wherein the electrically conductive second pattern comprises copper, silver, aluminum, gold, alloys thereof, or a combination thereof.

Item 10 is the electrically conductive film of any of items 1 to 9, wherein the plurality of first electrodes are in the form of wires, micro-wires, nano-wires, or a conductive layer.

Item 11 is the electrically conductive film of any of items 1 to 10, wherein the plurality of first electrodes are in the form of nano-wires.

Item 12 is the electrically conductive film of any of items 1 to 11, wherein the plurality of first electrodes comprise, copper, silver, gold, alloys thereof, indium tin oxide (ITO), or a combination thereof.

Item 13 is the electrically conductive film of any of items 1 to 12, further comprising an electrically conductive third pattern disposed on the substrate on a surface opposite of the electrically conductive first pattern.

Item 14 is the electrically conductive film of any of items 1 to 13, wherein the substrate is a multilayer polymeric film.

Item 15 is an electrically conductive film, comprising:

a web of dielectric material;

a plurality of electrically and physically intersecting electrically conductive rows and columns disposed on the web and defining a plurality of closed cells;

a plurality of substantially parallel electrically conductive spaced apart electrodes disposed on the web in each closed cell and adapted to form a plurality of drive or receive electrodes in a touch sensor, each electrode in a closed cell terminating at least one of the rows and columns in the plurality of the rows and columns defining the closed cell.

Item 16 is the electrically conductive film of item 15, wherein the dielectric material comprises a printable polymer, a sol-gel metal oxide, or an anodic oxide.

Item 17 is the electrically conductive film of item 15 or item 16, wherein the thickness of the dielectric material is between 0.1 and 10 microns.

Item 18 is the electrically conductive film of any of items 15 to 17, wherein the plurality of electrically and physically intersecting electrically conductive rows and columns comprises copper, silver, aluminum, gold, alloys thereof, or a combination thereof.

Item 19 is the electrically conductive film of any of items 15 to 18, wherein the plurality of substantially parallel electrically conductive spaced apart electrodes are in the form of wires, micro-wires, nano-wires, or a conductive layer.

Item 20 is the electrically conductive film of any of items 15 to 19, wherein the plurality of substantially parallel electrically conductive spaced apart electrodes are in the form of nano-wires.

Item 21 is the electrically conductive film of any of items 15 to 20, wherein the plurality of substantially parallel electrically conductive spaced apart electrodes comprise, copper, silver, gold, alloys thereof, indium tin oxide (ITO), or a combination thereof.

Item 22 is the electrically conductive film of any of items 15 to 21, wherein the web of dielectric material is a multilayer polymeric film.

Item 23 is an electrically conductive film for use in a touch sensor, comprising:

a dielectric substrate comprising a first region adapted to be used in a touch sensor and a second region, adjacent to the first region, not adapted to be used in the touch sensor;

a plurality of substantially parallel electrically conductive spaced apart first electrodes disposed on the substrate in the first region and adapted to form a plurality of drive or receive electrodes in a viewing region of the touch sensor;

an electrically conductive first pattern disposed on the substrate in the second region; and

a plurality of electrically conductive spaced apart first traces disposed on the substrate, a first end of each trace electrically and physically connected to a corresponding first electrode in the first region, an opposite second end of the trace extending into the second region and electrically connected to the conductive first pattern, the conductive first pattern electrically connecting the plurality of the first electrodes, at least portions of the first traces adapted to be used in a non-viewing border region of the touch sensor.

Item 24 is the electrically conductive film of item 23, wherein the dielectric substrate comprises a printable polymer, a sol-gel metal oxide, or an anodic oxide.

Item 25 is the electrically conductive film of item 23 or item 24, wherein the thickness of the dielectric substrate is between 0.1 and 10 microns.

Item 26 is the electrically conductive film of any of items 23 to 25, wherein the electrically conductive first traces comprise copper, silver, aluminum, gold, alloys thereof, or a combination thereof

Item 27 is the electrically conductive film of any of items 23 to 26, wherein the plurality of substantially parallel electrically conductive spaced apart first electrodes are in the form of wires, micro-wires, nano-wires, or a conductive layer.

Item 28 is the electrically conductive film of any of items 23 to 27, wherein the plurality of substantially parallel electrically conductive spaced apart first electrodes are in the form of nano-wires.

Item 29 is the electrically conductive film of any of items 23 to 28, wherein the plurality of substantially parallel electrically conductive spaced apart first electrodes comprise, copper, silver, gold, alloys thereof, indium tin oxide (ITO), or a combination thereof.

Item 30 is the electrically conductive film of any of items 23 to 29, wherein the dielectric material is a multilayer polymeric film.

Item 31 is an assembly, comprising:

a web of dielectric material having a length direction along a longer length dimension of the web and a width direction, perpendicular to the length direction, along a shorter width dimension of the web;

an electrically conductive elongated first pattern disposed on the web and extending along the length direction;

a plurality of substantially parallel electrically conductive spaced apart first electrodes disposed on the web and oriented along the width direction and adapted to form a plurality of drive or receive electrodes in a touch sensor, the first electrodes being physically and electrically isolated from the first pattern;

a drum positioned adjacent the web and comprising an electrically conductive second pattern disposed on an external surface of the drum, such that as the web moves along the length direction, the drum rotates in synchronism with the web, such that when the second pattern physically and electrically contacts a first electrode at a first location on the second pattern, the second pattern does not electrically contact the first pattern, and when the second pattern physically and electrically contacts the first electrode at a different second location on the second pattern, the second pattern physically contacts the first pattern.

Item 32 is the assembly of item 31, such that as the web moves along the length direction and the drum rotates in synchronism with the web, when the second pattern first comes in contact with a first electrode, the second pattern does not electrically contact the first pattern, but when the drum rotates further while maintaining contact with the first electrode, the second pattern contacts the first pattern.

Item 33 is the assembly of item 31, wherein the second pattern comprises an elongated connecting section extending along a rotation axis of the drum and opposing first and second end section extending from respective first and second ends of the connecting section in opposite directions along a circumference of the drum.

Item 34 is the assembly of item 31, wherein the drum comprises a plurality of electrically conductive substantially parallel spaced apart second patterns disposed on the external surface of the drum and electrically isolated from each other, such that as the web moves along the length direction, the drum rotates in synchronism with the web such that each second pattern contacts a corresponding first electrode at substantially a same first location on the second pattern so that the second pattern does not electrically contact the first pattern, and each second pattern contacts the corresponding first electrode at substantially a same second location on the second pattern so that the second pattern electrically contacts the first pattern.

Item 35 is the assembly of any of items 31 to 34, wherein each of the plurality of the first electrodes is oriented along the shorter width dimension of the web.

Item 36 is the assembly of any of items 31 to 35, wherein the dielectric material comprises a printable polymer, a sol-gel metal oxide, or an anodic oxide.

Item 37 is the assembly of any of items 31 to 36, wherein the thickness of the dielectric material is between 0.1 and 10 microns.

Item 38 is the assembly of any of items 31 to 37, wherein the plurality of electrically and physically intersecting electrically conductive rows and columns comprises copper, silver, aluminum, gold, alloys thereof, or a combination thereof.

Item 39 is the assembly of any of items 31 to 38, wherein the plurality of substantially parallel electrically conductive spaced apart electrodes are in the form of wires, micro-wires, nano-wires, or a conductive layer.

Item 40 is the assembly of any of items 31 to 39, wherein the plurality of substantially parallel electrically conductive spaced apart electrodes are in the form of nano-wires.

Item 41 is the assembly of any of items 31 to 40, wherein the plurality of substantially parallel electrically conductive spaced apart electrodes comprise, copper, silver, gold, alloys thereof, indium tin oxide (ITO), or a combination thereof.

Item 42 is the assembly of any of items 31 to 41, wherein the web of dielectric material is a multilayer polymeric film.

Item 43 is the assembly of any of items 31 to 42, further comprising an electrically conductive third pattern disposed on the web of dielectric material on a surface opposite of the electrically conductive first pattern.

Item 44 is a method of removing static electric charge from an electrically conductive pattern disposed on a web of dielectric material, comprising:

providing a web of dielectric material having first and second electrically conductive patterns disposed thereon, the second pattern electrically isolated from the first pattern and connected to a ground, the first pattern having a static electric charge thereon;

bringing an electrically conductive discharge path in electrical and physical contact with the first, but not the second, pattern so that at least a portion of the static electric charge transfers from the first pattern to the discharge path; and

bringing the electrically conductive discharge path in electrical and physical contact with the second pattern while maintaining contact with the first pattern so that at least a portion of the static charge transfers from the discharge path to the ground second pattern.

Item 45 is the method of item 44, wherein the dielectric material comprises a printable polymer, a sol-gel metal oxide, or an anodic oxide.

Item 46 is the method of item 44 or item 45, wherein the thickness of the dielectric material is between 0.1 and 10 microns.

Item 47 is the method of any of items 44 to 46, wherein the web of dielectric material is a multilayer polymeric film.

Item 48 is the method of any of items 44 to 47, further comprising an electrically conductive third pattern disposed on the web of dielectric material on a surface opposite of the electrically conductive first pattern.

Item 49 is the method of any of items 44 to 48, wherein the electrically conductive first pattern comprises copper, silver, aluminum, gold, alloys thereof, or a combination thereof

Item 50 is the method of any of items 44 to 49, wherein the electrically conductive second pattern comprises copper, silver, aluminum, gold, alloys thereof, or a combination thereof.

### EXAMPLES

The invention will be further understood with reference to the following illustrative examples. These examples are merely for illustrative purposes only and are not meant to be limiting on the scope of the appended claims.

### Comparative Example 1

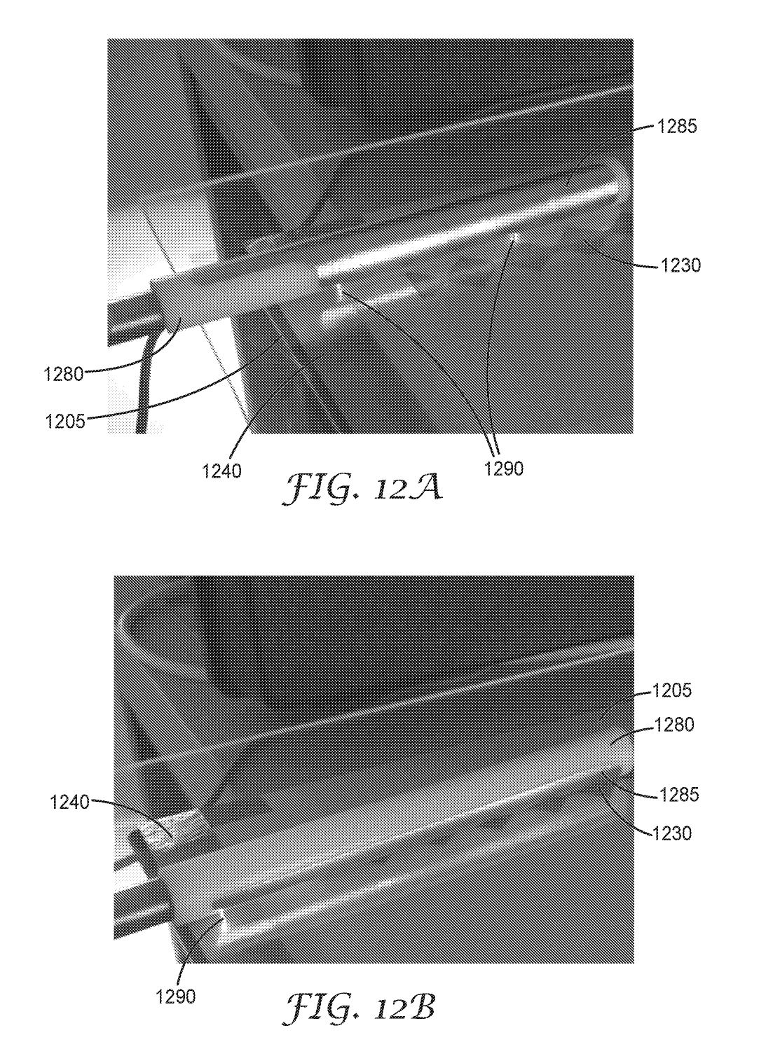

Comparative Example 1 demonstrates the results of an experiment in which ESD discharge is provided through a typical conductive drum. Referring to FIG. 12a, a substrate of dielectric material 1205 was provided having a length direction along a longer length dimension of the substrate D_{L} and a width direction, perpendicular to the length direction, along a shorter width dimension of the substrate D_{W}. The electrodes were simulated with an electrically conductive diamond shaped pattern 1230 formed of 3M 9713 conductive tape (commercially available from 3M Company, St. Paul, Minn.), having a diamond shape similar to the one typical for the touch sensor pattern referred to as a “diamond” pattern. The electrically conductive diamond shaped pattern 1230 was disposed on a polyethylene terephthalate (PET) dielectric substrate 1205, and oriented along the width direction D_{W} of the substrate 1205. The electrically conductive diamond shaped pattern 1230 was placed under a permanent 15 kV DC voltage to provide a charge. The electrically conductive pattern 1240, physically and electrically isolated from the electrically conductive diamond shaped pattern 1230, was provided on the substrate of dielectric material 1205 by 3M 1182 copper tape (commercially available from 3M Company, St. Paul, Minn.). The electrically conductive pattern 1240 was disposed on the substrate 1205 in a region not adapted to be used in a product such as a touch sensor, and extending along the length direction D_{L} of the substrate 1205. A drum 1280 was made of polytetrafluoroethylene (i.e., TEFLON) and included on the surface of the drum 1280 the electrically conductive elongated pattern 1285, provided by 3M 1182 copper tape.

When the drum 1280 was rotated, an electrical discharge (e.g., arc) 1290 occurred between the electrically conductive elongated pattern 1285 and the electrically conductive pattern 1240, as well as between the electrically conductive elongated pattern 1285 and the diamond shaped pattern 1230 (e.g., located in a functional area). Hence, electric discharges formed at various locations randomly at the simultaneous touching of the electrically conductive diamond shaped pattern 1230 and the electrically conductive pattern 1240, by the electrically conductive elongated pattern 1285. The electrical discharge 1290 in the electrically conductive diamond shaped pattern 1230 can damage the electrically conductive diamond shaped pattern 1230.

### Example 1

Example 1 demonstrates the results of an experiment in which ESD discharge is provided through a drum having an electrically conductive elongated pattern according to an embodiment of the present disclosure. Referring to FIG. 12b, a substrate of dielectric material 1205 was provided having a length direction along a longer length dimension of the substrate D_{L} and a width direction, perpendicular to the length direction, along a shorter width dimension of the substrate D_{W}. The electrodes were simulated with an electrically conductive diamond shaped pattern 1230 formed of 3M 9713 conductive tape (commercially available from 3M Company, St. Paul, Minn.), having a diamond shape similar to the one typical for the touch sensor pattern referred to as a “diamond” pattern. The electrically conductive diamond shaped pattern 1230 was disposed on a dielectric substrate 1205 formed of PET, and oriented along the width direction D_{W} of the substrate 1205. The electrically conductive diamond shaped pattern 1230 was placed under a permanent 15 kV DC voltage to provide a charge. The electrically conductive pattern 1240, physically and electrically isolated from the electrically conductive diamond shaped pattern 1230, was provided by 3M 1182 copper tape (commercially available from 3M Company, St. Paul, Minn.). The electrically conductive pattern 1240 was disposed on the substrate 1205 in a region not adapted to be used in a product such as a touch sensor, extending along the length direction D_{L} of the substrate 1205. A drum 1280 was made of polytetrafluoroethylene (i.e., TEFLON), and included on the surface of the drum 1280 the electrically conductive elongated pattern 1285, provided by 3M 1182 copper tape.

First, the charge potentials were equalized between the diamond shaped pattern 1230 and the electrically conductive elongated pattern 1285 by contacting the electrically conductive elongated pattern 1285 with the charged diamond shaped pattern 1230. Referring to FIG. 12b, when the drum 1280 was then rotated, the electrically conductive elongated pattern 1285 came into contact with the electrically conductive pattern 1240 and an electrical discharge (e.g., arc) 1290 occurred between the electrically conductive elongated pattern 1285 and the electrically conductive pattern 1240. In contrast, no arcs were observed on the diamond shaped pattern 1230 (e.g., located in a functional area).

### Example 2

Example 2 demonstrates the results of an experiment in which ESD discharge is provided through shunts. A transparent and conductive silver nanowire substrate was prepared as described in WO 2014/088950, such that the sheet resistance of the PET-coated substrate was approximately 50 Ohms per square. This substrate was used as the input material of a roll-to-roll process that patterned the nanowire coating via the following process steps (whose basic patterning steps are described in Embodiment 1 of WO 2014/088950):

1. A patterned resist layer was printed on the nanowire-coated PET with a flexographic printing station, utilizing a 1.0 BCM/in² anilox roll and a 67 mil (1.7 mm) thick DuPont DPR high resolution flexographic stamp provided by Southern Graphics Systems (SGS, Minneapolis, Minn.). The flexographic printing plate was designed to incorporate cross-web electrodes (i.e., perpendicular to the direction of web motion) with a 5 mm pitch, along with shunts across the two ends of the electrodes to electrically connect the electrodes together during the patterning process. The printing ink, used as the resist material, was Flint Group UFRO-0061-465U (Flint Group Print Media North America, Batavia, Ill.), which was subsequently cured (i.e., solidified) with an “H bulb” UV-curing lamp (UV-Ray Lamp head type Maxwell 550-Lamp type UVH5519-600); UVRay, Italy). The resist was printed at a speed of 20 feet per minute (6.1 meters per minute).

2. A layer of 99.75% MacDermid Print and Peel (MacDermid Inc., Denver, Colo.) and 0.25% Tergitol 15-s-7 (available from Sigma Aldrich, St. Louis, Mo.) was gravure coated with a 24 billion cubic microns per square inch (BCM/in²) (3.72 BCM/cm²) anilox at 20 feet/minute (6.1 meters per minute) and dried (i.e., solidified by evaporation of solvent) via a combination of IR and air impingement ovens.

3. A 3M 3104C (3M Company, St. Paul, Minn.) pre-mask liner was laminated to the exposed surface of the MacDermid Print and Peel layer, and a roll of material was removed from the process line.

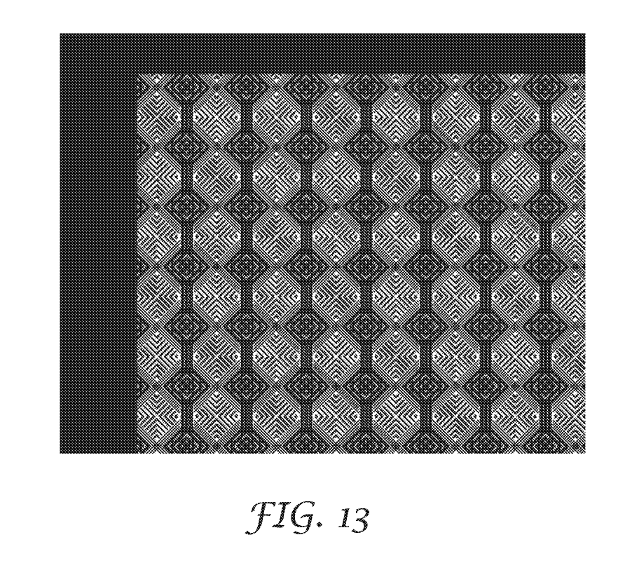

4. Samples of the printed cross-web electrode artwork were cut from the roll fabricated in step (3). The pre-mask liner and attached MacDermid Print and Peel strippable polymer coating were peeled from the substrate, leaving a pattern of silver nanowire on the PET substrate. The patterned nanowire layer was that as illustrated in FIG. 13. Referring to FIG. 13, the dark portions of the pattern in are the nanowires, whereas the contrasting light portions of the pattern are where the nanowires were removed when the strippable polymer coating was peeled from the substrate. The electrodes are illustrated in FIG. 13 to be provided as columns, while the web was moved in a direction perpendicular to the columns (e.g., in the row direction).

Stated another way, the electrically conductive film of FIG. 13 includes a dielectric substrate having a first region adapted to be used in a touch sensor (i.e., the region including the columns of electrodes) and a second region, adjacent to the first region, not adapted to be used in the touch sensor (i.e., the region including the shunt illustrated connecting the ends of the columns of electrodes). The electrically conductive film includes a plurality of substantially parallel electrically conductive spaced apart first electrodes disposed on the substrate in the first region and adapted to form a plurality of drive or receive electrodes in the touch sensor, and an electrically conductive first pattern disposed on the substrate in the second region (e.g., a solid region of conductive nanowires). Each first electrode extends into the second region and is electrically and physically connected to the conductive first pattern, the conductive first pattern electrically connecting the plurality of the first electrodes. The second region is electrically connected to ground.

The shunts joining the cross-web electrodes at the two opposing ends of the electrodes in each sample from step (4) were manually removed with scissors, isolating each of 104 cross-web electrodes for every repeat pattern of silver nanowire. The resistance of each of the 104 cross-web electrodes were measured with an ohm meter (for all samples from (4)), and no opens in resistance were detected (i.e., all tested electrodes were conductive and free of electrostatic defects).

In contrast, steps (1) through (4) were repeated for a pattern that was the same as the pattern of FIG. 13 except lacking the shunts at the opposing ends of the electrodes, and all measured samples exhibited opens in resistance due to electrostatic defects.

The complete disclosure of all patents, patent documents, and publications cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. An electrically conductive film for use in a touch sensor, comprising:
a dielectric substrate comprising a first region adapted to be used in a touch sensor and a second region, adjacent to the first region, not adapted to be used in the touch sensor;
a plurality of substantially parallel electrically conductive spaced apart first electrodes disposed on the substrate in the first region and adapted to form a plurality of drive or receive electrodes in the touch sensor; and
an electrically conductive first pattern disposed on the substrate in the second region, each first electrode extending into the second region and electrically and physically connected to the conductive first pattern, the conductive first pattern electrically connecting the plurality of the first electrodes.

2. The electrically conductive film of claim 1, wherein the second region completely encloses the first region and the electrically conductive first pattern completely encloses the plurality of the first electrodes.

3. The electrically conductive film of claim 1, further comprising an electrically conductive second pattern disposed on the substrate in the first region and at least partially overlaying and contacting the first electrodes, the first electrodes adapted to be used in a viewing region of a touch sensor and the second pattern adapted to be used in a non-viewing border region of the touch sensor.

4. The electrically conductive film of claim 3, wherein the second pattern extends into the second region and electrically and physically connects to the conductive first pattern.

5. The electrically conductive film of claim 1, wherein the first region comprises an electrode region comprising the plurality of the first electrodes and adapted to be used primarily in a viewing region of a touch sensor, and a trace region adapted to support a plurality of electrically conductive traces and be used primarily in a non-viewing border region of the touch sensor, the trace region not comprising any electrically conductive pattern thereon.

6. An electrically conductive film, comprising:
a web of dielectric material;
a plurality of electrically and physically intersecting electrically conductive rows and columns disposed on the web and defining a plurality of closed cells;
a plurality of substantially parallel electrically conductive spaced apart electrodes disposed on the web in each closed cell and adapted to form a plurality of drive or receive electrodes in a touch sensor, each electrode in a closed cell terminating at least one of the rows and columns in the plurality of the rows and columns defining the closed cell.

7. An electrically conductive film for use in a touch sensor, comprising:
a dielectric substrate comprising a first region adapted to be used in a touch sensor and a second region, adjacent to the first region, not adapted to be used in the touch sensor;
a plurality of substantially parallel electrically conductive spaced apart first electrodes disposed on the substrate in the first region and adapted to form a plurality of drive or receive electrodes in a viewing region of the touch sensor;
an electrically conductive first pattern disposed on the substrate in the second region; and
a plurality of electrically conductive spaced apart first traces disposed on the substrate, a first end of each trace electrically and physically connected to a corresponding first electrode in the first region, an opposite second end of the trace extending into the second region and electrically connected to the conductive first pattern, the conductive first pattern electrically connecting the plurality of the first electrodes, at least portions of the first traces adapted to be used in a non-viewing border region of the touch sensor.

8. An assembly, comprising:
a web of dielectric material having a length direction along a longer length dimension of the web and a width direction, perpendicular to the length direction, along a shorter width dimension of the web;
an electrically conductive elongated first pattern disposed on the web and extending along the length direction;
a plurality of substantially parallel electrically conductive spaced apart first electrodes disposed on the web and oriented along the width direction and adapted to form a plurality of drive or receive electrodes in a touch sensor, the first electrodes being physically and electrically isolated from the first pattern;
a drum positioned adjacent the web and comprising an electrically conductive second pattern disposed on an external surface of the drum, such that as the web moves along the length direction, the drum rotates in synchronism with the web, such that when the second pattern physically and electrically contacts a first electrode at a first location on the second pattern, the second pattern does not electrically contact the first pattern, and when the second pattern physically and electrically contacts the first electrode at a different second location on the second pattern, the second pattern physically contacts the first pattern.

9. The assembly of claim 8, such that as the web moves along the length direction and the drum rotates in synchronism with the web, when the second pattern first comes in contact with a first electrode, the second pattern does not electrically contact the first pattern, but when the drum rotates further while maintaining contact with the first electrode, the second pattern contacts the first pattern.

10. The assembly of claim 8, wherein the second pattern comprises an elongated connecting section extending along a rotation axis of the drum and opposing first and second end section extending from respective first and second ends of the connecting section in opposite directions along a circumference of the drum.

11. The assembly of claim 8, wherein the drum comprises a plurality of electrically conductive substantially parallel spaced apart second patterns disposed on the external surface of the drum and electrically isolated from each other, such that as the web moves along the length direction, the drum rotates in synchronism with the web such that each second pattern contacts a corresponding first electrode at substantially a same first location on the second pattern so that the second pattern does not electrically contact the first pattern, and each second pattern contacts the corresponding first electrode at substantially a same second location on the second pattern so that the second pattern electrically contacts the first pattern.

12. The assembly of claim 8, wherein each of the plurality of the first electrodes is oriented along the shorter width dimension of the web.

13. (canceled)

14. The electrically conductive film of claim 1, wherein the dielectric substrate comprises a printable polymer, a sol-gel metal oxide, or an anodic oxide.

15. The electrically conductive film of claim 1, wherein the plurality of first electrodes are in the form of wires, micro-wires, nano-wires, or a conductive layer.

16. The electrically conductive film of claim 1, wherein the plurality of first electrodes are in the form of nano-wires.

17. The electrically conductive film of claim 6, wherein the web of dielectric material is a multilayer polymeric film.

18. The electrically conductive film of claim 7, wherein the plurality of substantially parallel electrically conductive spaced apart first electrodes comprise, copper, silver, gold, alloys thereof, indium tin oxide (ITO), or a combination thereof.
